(19) United States
(12) Patent Application Publication
(10) Pub. No.: US 2026/0017395 A1
(43) Pub. Date: Jan. 15, 2026

(54) File Access Control Policy

(71) Applicants: Jun Yu, Clarksburg, MD (US); Amy S. Yu, Seattle, WA (US)

(72) Inventors: Jun Yu, Clarksburg, MD (US); Amy S. Yu, Seattle, WA (US)

(73) Assignee: Jun Yu, Clarksburg, MD (US)

(21) Appl. No.: 18/769,553

(22) Filed: Jul. 11, 2024

(51) Int. Cl. G06F 21/62

(52) U.S. Cl. CPC G06F 21/6218

(57) ABSTRACT

Embodiments of this invention employ policies to determine permissions to be used to control users' access to files. The policies comprise conditions to match the metadata of files, conditions to match the properties of devices, conditions to match the attributes of users and a set of permissions. Upon receiving a request from a user to access a file on a device, the matching policies are selected by matching the file's metadata, the user's attribute and the properties of the device, and the final permissions are determined by merging the permissions from the matching policies. The final set of permissions can be used by applications to enforce the access of the file by the user on the device in the request.

### TECHNICAL FIELD

The field of the invention relates to computer file access control, and in particular, a method and system for determining access permissions to a file by a user on a device.

### BACKGROUND OF THE INVENTION

A computer data file, as used herein, encompasses any file stored on a computing device and storage device that is recognized and manipulated as a distinct entity by a file system or application, including those stored on remote storages. Files may also include archive type files such as ZIP format files.

Unauthorized access to data files poses a significant threat to enterprises, organizations, governments, and personal privacy. Simultaneously, with increased connectivity, file sharing has surged. Controlling who can access files and when has become central to cybersecurity, but achieving a balance between sharing files and access control remains a challenge. While every file system applies access control to each file, this control does not transfer to other file systems when files are copied to different devices. Some solutions use policies to enhance file system access control but struggle to provide consistent access control across different file systems. Other solutions rely on access control lists (ACLs) to grant file access to specified users while denying access to others. However, linking ACLs to each individual file becomes unwieldy to manage and difficult to scale as the number of files grows into the millions and beyond.

Therefore, there is a need for a method and system that can scale to consistently and granularly manage access rights for millions of files across diverse devices.

### BRIEF SUMMARY OF THE INVENTION

Embodiments of this invention provide a method and system to store a pool of access policies, each policy comprises conditions that match to (1) files' metadata, (2) users' attributes and (3) devices' properties, and a set of access permissions that become the output of the policy when all the conditions match to those from a request.

When receiving a request file from a user to access a file on a device, the file's metadata, the user's attributes, and the device's properties are retrieved, and matching policies are identified by matching metadata of the file, attributes of the user, and properties of the device to each of the policies in the pool, and generates a final set of permissions by merging the permission set from the matching policies.

### BRIEF DESCRIPTION OF THE DRAWINGS

FIG. 1 shows a sample data structure representing access policy in one embodiment of this invention.

FIG. 2A shows sample values of access permissions in one embodiment of this invention.

FIG. 2B shows sample rules to merge permission sets from two different policies into one set in one embodiment of this invention.

FIG. 2C shows sample data structures of file metadata, user attributes and device properties that can be used in access policies in one embodiment of this invention.

FIG. 3 shows an operation of a system to determine the access permissions for a file in an access request by a user on a device in accordance with one embodiment of this invention.

FIG. 4 shows a block diagram of a computing device on which the present invention may be implanted.

FIG. 5A shows a block diagram of a computing device on which the policies are stored and evaluated in accordance with one embodiment of this invention.

FIG. 5B shows a block diagram of a computing device on which a file is accessed by a user in accordance with one embodiment of this invention.

### DETAILED DESCRIPTION OF THE INVENTION

Presently, file access is managed by the file system the file is stored on, which allocates three sets of permissions determining access rights according to ownership types: the file owner, the group owner (including users in the same group as the owner), and system administrators. When a user attempts to open a file, the file system first verifies the user's ownership status by examining the user's identity and group memberships on the system. If the user lacks ownership rights for the file, access is denied. Conversely, if the user is identified as an owner or part of an ownership category, the file system grants permissions based on the ownership type.

The standard file system permissions typically consist of read, write, and execute permissions. Read only permission enables users to access the data stored in a file without the ability to overwrite the existing file, which keeps the file unchanged. Write permission allows users to read and modify the content of the file, while execute permission further allows users to both read and run the file if it is executable.

More granularly, the application responsible for handling the file's contents can regulate access to its data. This controlled access may encompass tasks like sending content to a printer or copying partial or complete contents to a system's clipboard, facilitating retrieval of the copied contents by operating systems and other applications with access to the clipboard.

To control access to files stored on remote storage, organizations most commonly rely on an Access Control List (ACL) system. ACLs consist of a list of aliases representing users and/or groups, and each file can be linked to one or more ACLs. When a user seeks access to a file, the storage system retrieves the user's aliases and group memberships, as well as the ACLs associated with the file. It then checks for any matches between the user's aliases and those in the linked ACLs. If a match is found with any linked ACL, the user is authorized to download the file based on the permissions granted by the corresponding ACLs. Upon downloading, the user becomes the owner of the downloaded file, which is essentially a copy of the requested file on the user's device. This copy provides the user with read, write, and execute permissions equivalent to the file system's permission to the owner.

Furthermore, a user might be linked with ACLs permitting file uploads. If authorized, the user can proceed to upload a file. In cases where a file with the same name and location as the uploaded file already exists, the storage system has the option to either overwrite the existing file with the new upload or generate a new version of the file while retaining the current one. This upload procedure aligns with the file system's write permission. However, ACLs on remote storage generally do not grant file execution privileges.

Alternative approaches exist to incorporate ACLs or policies into the file system to adjust the default access control mechanism. For example, a system could intercept file access requests and assess whether the user is utilizing a command like “sudo” in UNIX to assume the identity of another user for the request. In such scenarios, the system may reject these requests before they reach the file system's access control. Consequently, any file access request made using an identity-altering command would be denied.

The file system-based access control is effective for files stored within the file system itself. However, this control may not be retained if the same file is copied by a different user or transferred to other file systems, even if the copied or transferred file contains identical data. For instance, if user A has read-only access to a file D owned by user B, and user A copies file D to his directory, renaming it to F. User A now has read, write, and execute permissions for file F as its owner which granting user A the ability to execute file F, even though A couldn't do so with file D. However, user A can only make changes to file F but not file D.

The users who belong to the same group as user A may gain access to file F even if he doesn't have access to file D. Moreover, a user in that group could transfer file F to another device via a computer network, thereby extending access to the contents of file D to the users who have access to the new device via File F.

Similarly, remote storage systems relying on ACLs encounter the same constraints. For instance, if a user downloads file H from the storage to a local device and renames it J, the user can share file J with user K, even if user K doesn't have access to file H per the linked ACLs. User K can then further share the file J with users L and M through emails.

Both file system and ACL system are limited to controlling access to the files stored on the system. However, a file may have multiple copies stored on different file systems or remote storages, each subject to different access controls despite containing the same data. This lack of unified access control over identical data complicates data security and privacy implementation.

Embodiments of this invention provide a method and system for using data access policies to establish access permissions for data files. The process comprising receiving a request from a user to access a file on a device, retrieving the attributes associated with the user, the metadata of the data file, and the properties of the device, identifying the matching policies from a pool of policies that match the metadata of the data file, the user's attributes, and the properties of the device, and combining the permissions from the matching policies to create a final set of permissions for the request. The final permissions may be sent back to the device where the request originated to be used to control the access to the file by the user on the device.

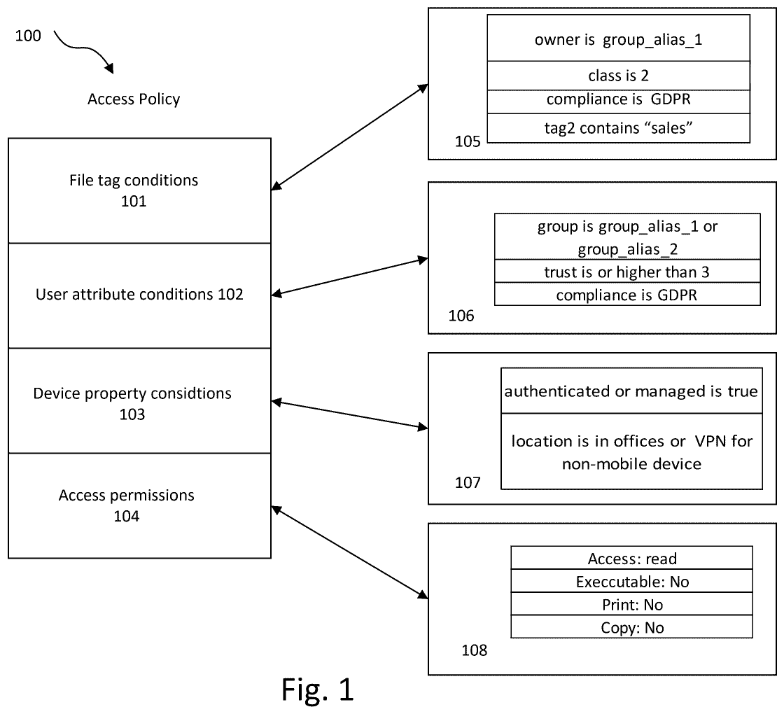

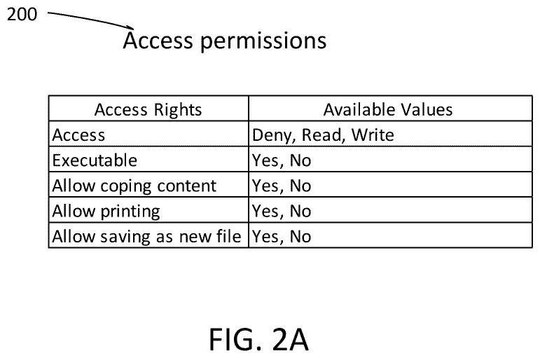

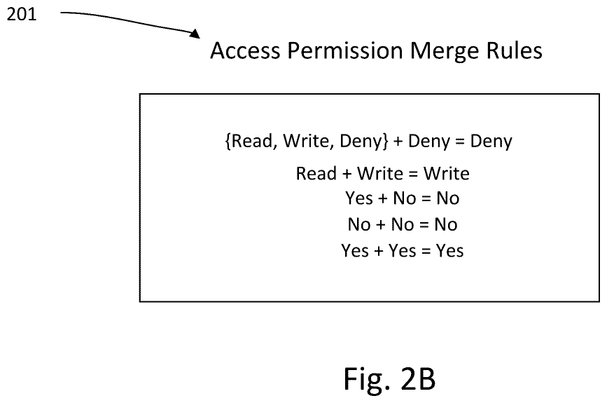

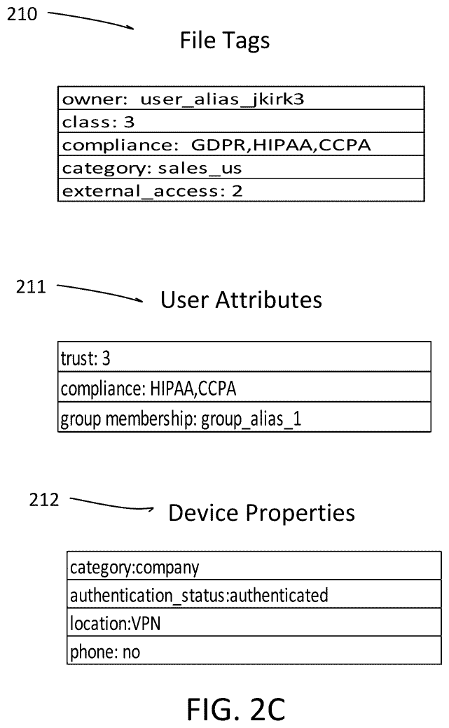

To illustrate embodiments of this invention more concretely, the following provides variations and examples of various aspects of embodiments of the invention. Specifically, to better illustrate the architecture and processes of embodiments of this invention described below, FIG. 1 provides sample data structures and example values of an access policy, FIG. 2A-2C provide sample data structures and values of file's metadata, user's attributes and device's properties, and a sample rules to merge multiple permission set into one. It will be appreciated that the following variations and examples are not intended to be exhaustive or to limit the invention to the precise forms disclosed. These variations and examples are to provide further understanding of embodiments of the present invention.

### Data Structures and Components of Access Policy

FIG. 1 shows a sample data structures representing access policies, including file metadata conditions 101, user attributes condition 102, device properties condition 103 and permission set 104 in accordance with embodiments of this invention. Although specific data structures may be shown (key-value pairs and comparison operators, FIG. 1 and FIG. 2A-2C), any data structure may be used, including but not limit to arrays, lists, JavaScript Object Notation (JSON) and extensible markup languages (XML). Additionally, each of the data structure may be presented in variety of ways, including being sorted by keys. Furthermore, these data structures may be stored in volatile or non-volatile memory including cache, and in various formats, including plain text and in databases.

Firstly, the file metadata conditions 101 comprises a set of conditions 105 to match metadata of a requested file. One embodiment of the conditions 105 as shown in FIG. 1 are constructed using key-value pairs and comparison operators. This example includes (1) a key-value pair with the key of “owner” and the value of group_alias_1, with the operator of “=” or “is”’; and (2) a key-value pair with the key of “class” and the value of 2, with the operator of “=” or “is”; and (3) a key-value pair with the key of “compliance” and the value of “GDPR”, with the operator of “=” or “is”; and (4) a key-value pair with the key of “tag2” and the value of “sales”, with the operator of “contain” or “E”. The conditions are deemed to match only if the metadata of a file contains all four specified keys, and if the comparison of each key's value in the file's metadata to the corresponding value in the conditions, using the corresponding comparison operator, evaluates to true for all keys. Otherwise, it is concluded that the conditions do not match the requested file. However, the criteria for each condition to be deemed to match can be differ between implementations. In another embodiment, the conditions may be deemed to match if the metadata of a file contains at least one specified key, and if the comparison of at least one key's value in the conditions to the corresponding value in the conditions.

Secondly, the user attributes condition comprises a set of conditions 106 to match a user in a request. One embodiment of the conditions 106 as shown in FIG. 1 are constructed using key-value pairs and comparison operators. This example includes (1) a key-value pair with the key of “group” and the value “group_alias_1 or grou_alias_2”, with the comparison operator of “=” or “is”; and (2) a key-value pair with the key of “trust” and the value of “3”, with the operator of “>”, or “higher than”; and (3) a key-value pair with the key of “compliance” and the value of “GDPR”, with the operator of “=” or “is”. The conditions are considered to match, in this embodiment, only if the user's attributes contain all three specified keys, and if the comparison of each key's value in the user's attributes to the corresponding value in the conditions, using the corresponding comparison operator, evaluates to true for all keys. Otherwise, it is determined that the conditions do not match the request for the file.

Thirdly, the device property condition 103 comprises a set of conditions 107 to match a device in a request. One embodiment of the conditions 107 as shown in FIG. 1 are constructed using key-value pairs and comparison operators. This example includes (1) a key-value pair with the key of “authenticated” for non-mobile devices or “managed” for mobile devices and the value is “true”, with the operator “=” or “is”; and (2) a key-value pair with the key of “location” and the value of “in office or via VPN for non-mobile device”, with the operator of “=” or “is”. The conditions are considered to match, in this embodiment, only if the device's properties contain both specified keys, and if the comparison of each key's value in the device's properties to the corresponding value in the conditions, using the corresponding comparison operator, evaluates to true for all keys. Otherwise, it is determined that the conditions do not match the request for the file.

Finally, the permission set 104 comprises a set of permissions 108 as the outcome of the policy when policy conditions match to a request. One embodiment of the conditions 107 as shown in IG.1 are constructed using key-value pairs and comparison operators. This example includes (1) a key-value pair with the key of “access” and the value of “read”; and (2) a key-value pair with the key of “executable” and the value of “no”; and (3) a key-value pair with the key of “print” and the value of “no”; and (4) a key-value pair with the key of “copy” and the value of “no”.

Each of the three parts-file metadata, user attributes, and device properties—may include a “match-all” key that serves as a wildcard, matching any input or value for that specific part. The “match-all” key provides a way to set a default or catch-all rule that applies universally to all inputs within that condition, unless more specific rules are defined.

In the file metadata, for example, the “match-all” key could be represented by a value such as “all_files”. Setting the value of the “all_files” key to “allow” would result in matching all files, whereas setting it to “block” would match none.

Similarly, in the user attributes, the “match-all” key could be represented by a value like “all_users”. Setting the “all_users” value to “allow” would result in matching all users, whereas setting it to “block” would match none.

Likewise, in the device properties, the “match-all” key could be represented by a value such as “all_devices”. An “allow” value for “all_devices” would match all devices, whereas a “block” value would match none.

Policies do not require conditions for each of the three components-file metadata, user attributes, and device properties. The absence of conditions in any of these components can serve as an alternative implementation of the “match-all” condition mentioned earlier, for example.

In one embodiment, if a policy lacks conditions related to file metadata, it effectively means that the policy applies to all files, regardless of their specific metadata values or attributes. Similarly, if a policy does not include conditions on user attributes, it implies that the policy applies to all users, irrespective of their individual attributes or group memberships. Likewise, the absence of conditions on device properties indicates that the policy applies to all devices, without considering their specific configurations or security postures.

This approach can be useful in scenarios where a broad, catch-all policy is desired, or when the focus is primarily on the conditions specified for the other components. For example, an organization might implement a policy that allows all users to access files of a certain classification level, regardless of the device being used or the file's metadata. In this case, the policy would only include conditions related to the file's classification level and user attributes, while omitting conditions on device properties.

Furthermore, the value of each key could incorporate wildcards and wildcard patterns, allowing for more flexible and inclusive policy definitions. This enables broad applicability or specific exceptions based on defined requirements. For example, in the file metadata table, the “category” key could have asterisk (*) as a wildcard to match all file categories, or it could have a specific wildcard pattern (e.g., “sales_*”) to match files whose categories start with “sales_”. This would ensure that the policy applies to files across all categories or matches any category that follows the “sales_” pattern, respectively. In this embodiment, the wildcard pattern “sales_*” would match categories like “sales_us” and “sales_eu”.

Similarly, in the user attributes table, the “group” key could have a wildcard value, such as an asterisk (*), which would allow the policy to apply to users belonging to any group within the organization, rather than being restricted to specific group memberships. This wildcard value provides broader inclusivity while still maintaining control over the targeted user groups.

The same concept applies to device properties, where a wildcard value, such as an asterisk (*) for the “location” key could encompass devices connected from any network source, including internal networks, VPNs, or external connections.

Furthermore, policies may support comparison of values across file metadata, user attributes, and device properties, to reduce the number of policies required to achieve the desired effect. For instance, a policy may contain a condition that a file's “compliance” value should intersect or be a subset of a user's “compliance” value. Using the example shown in FIG. 2C, if a file's “compliance” value is “HIPAA”, and a user's “compliance’ value includes “HIPAA” and “CCPA”, the condition would be met as the file's compliance values are a subset of the user's compliance values.

Similarly, a policy can also include a condition that requires a user's “trust” value to be equal to or greater than (2) a file's “class” value. This condition ensures that users with a specific trust level can access files with a corresponding or lower classification level, aligning with the principle of least privilege.

Although allowing cross-component value comparisons can enable more complex and comprehensive rules to be defined while minimizing the number of individual policies required, it is worth noting that this is only a shortcut in implementation when dealing with comparable values, and the same results can also be achieved without the cross-part comparison. For instance, instead of using a cross-component condition that compares a user's “trust” value with a file's “class” value, the same access control objective can be achieved by defining multiple policies, each with separate conditions. One condition would match the file's “class” value to a specific value, while another condition would require the user's “trust” value to be equal to or greater than that same value. By creating separate policies for each file “class” value and the corresponding minimum user “trust” value, users would only be granted access to files with a classification level at or below their assigned trust level by the policies.

It is anticipated that the data structures of file metadata, user attributes and device properties align with the keys in the policy to facilitate the value comparison. However, this alignment isn't always guaranteed. For example, a legacy user identify management system may lack the key of “trust” but instead a key of “trust_level” where the value of 5 may equal to the 3 associated with the key of “trust” in the new system. In such cases, additional data normalization processes may be used to translate or convert the different keys and values into the formats acceptable by the policies for evaluation.

Although a condition may consist more than one key-value pairs, such as seen in the device property conditions 107, the inputs from the request are typically expected to have only one of pairs. For instance, one condition in device property conditions 107 evaluates the “authenticated” key, presents only in no-mobile devices, or the “managed” key, exclusive to mobile devices. This condition is compared with device property of either the key of “authenticated” or “managed”, of whichever a valid value is presented.

FIG. 2A depicts sample data structures of access permissions used by access policies. Table 200 presents sample access permissions that consists of access rights and their corresponding values. The access right, which controls user access to a file's contents and the ability to modify the file. The value of the access right includes “deny”, “read” and “write”. When set to “deny”, access to file contents is rejected, along with any subsequent rights. “Read” grants users access to the contents of a file but prohibits modification to the file, while “write” allows changes to the file itself and access to file contents. In common file systems, “read” in this embodiment equates to read-only access and “write” corresponding to read-write access.

The “execute”, or “executable” as in FIG. 2A, right has a binary value of “yes”, and “no”. When set to “yes”, users are permitted to execute or run files if the file contents are executable; otherwise “no” indicates files cannot be executed or run. It's important to note that “execute” is secondary to access rights, meaning users can execute files only when granted “read” or “write” permissions.

The “copy” right, or “Allow coping content” as in FIG. 2A, controls users' the ability to duplicate selected content from a file or application into a system clipboard. The data stored in the clipboard can then be pasted or inserted into other applications or accessed by operating system and other applications which have the privilege to interact with the clipboard. This right facilitates the transfer and sharing of information across different applications and contexts within the system.

The “print” right, or, “Allow printing” as in FIG. 2A, governs a user's ability to output the contents of a file or document to a printing device. This permission encompasses both physical printers, which produce hard copies of the content on paper, and virtual printers, which generate digital representations of the content in various file formats. When a user has the “print” right granted, they can send the file's contents to any available printing device connected to the system. In the case of physical printers, the output will be a printed version of the document on paper. On the other hand, virtual printers allow users to create digital copies of the file's contents, typically in formats such as PDF, XPS, or other document formats supported by the virtual printer software. The “Allow saving as new file” in FIG. 2A controls a user's ability to save the current content as a new file. When a user is granted with this right, he can save the content into a new file in formats supported by the application, even if his access right is read-only.

Akin to the “execute” right, “copy”, “print” and “saving as new file” rights are also binary in nature with the possible value of “yes” and “no”. Those are dependent on the user having the “read” and “write” right to the file in question.

While access rights and the “execute” right are typically enforced at the file system level, the “copy”, “print” and “save as new file” rights are commonly controlled by applications that handles the respective file format. For instance, a PDF reader application would be responsible for enforcing the “copy” and “print” permissions for PDF documents, allowing or denying users the ability to copy content or print the document based on the configured permissions.

The unified access rights system presented in this invention allows for more granular control over specific actions that users can perform on file contents, beyond the basic file system permissions. In the embodiments where files are encrypted, the access right should apply to the decrypted content of the files. By separating the enforcement of “copy” and “print” permissions from the file system, applications can provide additional layers of security and control over sensitive information, even for users who have “read” access to the files.

FIG. 2B shows sample rules to merger two set of rights into one. The accesses rights merge rules 201 are a set of formulars that takes two values for each right as input and produce a consistent output of one value.

For access rights, if either input is “deny”, the output is undisputedly also “deny”. If both inputs are identical, either “read” or “write”, the output is undisputedly the same. In cases where one input is “read” and the other is “write”, the output is “write”, as shown in FIG. 2B.

For the rights that are binary, if both inputs are “yes”, the output is undisputedly “yes”, otherwise the output is “no”, as shown in FIG. 2B.

The access rights in 200 and merge rules in 201 are simply sample implementation and are not meant to be exhaustive or restrictive. They are used for the purpose of better illustrating the invention and embodiments.

FIG. 2C illustrates sample data structures for file metadata 210, user attributes 211, and device properties 212.

Table 210 contains examples of manually added file metadata represented as key-value pairs, although they may also be presented in other data structures such as array, list, or JSON. File metadata is commonly known as descriptive information about a file, distinct from the file's actual content. While some file metadata is automatically generated by the system upon file creation, such as file size or creation date, other metadata elements can be manually added or modified. The policies commonly utilize the manually added metadata, also known as tags or labels, as these remain consistent across all instances, regardless of the file system or location where the file resides. However, policies can leverage all available metadata elements to meet specific requirements or objectives.

In the table 210, “owner” key has a value of “user_alias_jkirk3,” which represents an alias or identifier for a specific user associated with the file. The “class” key has a value of “3,” which could indicate a classification level or sensitivity rating for the file.

The “compliance” key in this embedment has a value that is a comma-separated list of three strings: “GDPR, HIPPA, CCPA.” This value allows the file to be matched with policies that have a “compliance” key and a value containing any combination of these three strings, representing compliance with the General Data Protection Regulation (GDPR), the Health Insurance Portability and Accountability Act (HIPAA), and the California Consumer Privacy Act (CCPA).

The “category” key has a value of “sales_us,” which could be used to categorize the file as related to sales in the United States region. Finally, the “external_access” key has a value of “2,” which may represent a specific level of access control or permissions for external users or entities.

Table 211 contains examples of user attributes represented as key-value pairs. User attributes are the properties or characteristics assigned to a user account and are typically stored in identity management system, accessible by authorized systems and applications, and may be presented in data structures other than key-value pairs, such as array, list, or JSON.

In this example, the “trust” key has a value of “3,” which could indicate the user's level of trust, or the highest classification level of files the user is authorized to access. The “compliance” key has a value that is a comma-separated list of two strings: “HIPAA” and “CCPA.” This attribute may signify the user's authorization to access files subject to compliance with the Health Insurance Portability and Accountability Act (HIPAA) and the California Consumer Privacy Act (CCPA). The “group” key has a value of “group_alias_1,” which represents an alias or identifier for a specific group or role membership associated with the user.

Table 212 showcases examples of device properties represented as key-value pairs. Device properties are attributes assigned to a specific device to represent its characteristics, configurations, or current status. These properties play a crucial role in determining the trust level associated with the device, which ultimately influences the classification level of files that can be accessed or processed on that device. Device properties can include a wide range of attributes, such as the operating system version, device type (e.g., desktop, laptop, mobile), hardware specifications, security software installations, and network configurations. These properties provide valuable insights into the device's security posture, enabling organizations to implement risk-based access controls and data protection measures. For instance, a device with up-to-date security software, encrypted storage, and a secure network connection may be assigned a higher trust level, allowing it to access files with higher sensitivity or classification levels. Conversely, a device with outdated software, unencrypted storage, or a potentially compromised network connection may be assigned a lower trust level, restricting its access to highly sensitive data. Furthermore, device properties can be dynamically monitored and updated, enabling real-time adjustments to access controls and data protection measures based on changes in the device's status or environment. Those properties are typically stored in device management and real time monitoring system, accessible by authorized systems and applications, and may be presented in data structures other than key-value pairs, such as array, list, or JSON.

In this example, the “category” key has a value of “company,” which likely indicates that the device is issued and managed by the organization. This designation typically implies that the device adheres to corporate security policies and management standards. The “authentication” key has a value of “yes,” signifying that the device has been authenticated by the organization's identity and access management system, such as a Windows NT domain or a centralized authentication server. This authentication process helps ensure that only authorized devices can access corporate resources and data. The “location” key has a value of “VPN,” suggesting that the device is currently connected to the organization's internal network through a Virtual Private Network (VPN) connection. This secure remote access mechanism allows the device to access internal resources and data as if it were physically connected to the corporate network, while maintaining a secure and encrypted communication channel. Furthermore, the “phone” key has a value of “no,” indicating that the device in question is not a mobile phone.

### Process and Architect

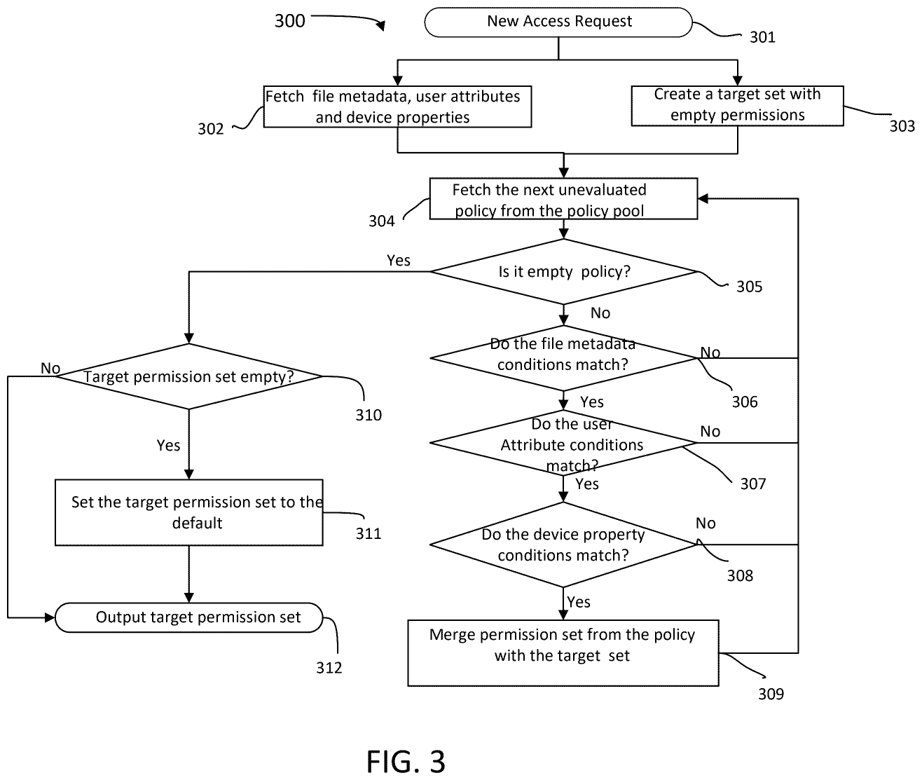

FIG. 3 shows one process 300 to determine the access permissions for a request for a user to access a file on a device with access policy. It is expected that a policy pool typically comprises a plurality of policies, each policy within the pool should be evaluated for every request. Thus, the process evaluating a policy for the request is iterated through each policy within the pool until the there is no valid unevaluated policy left.

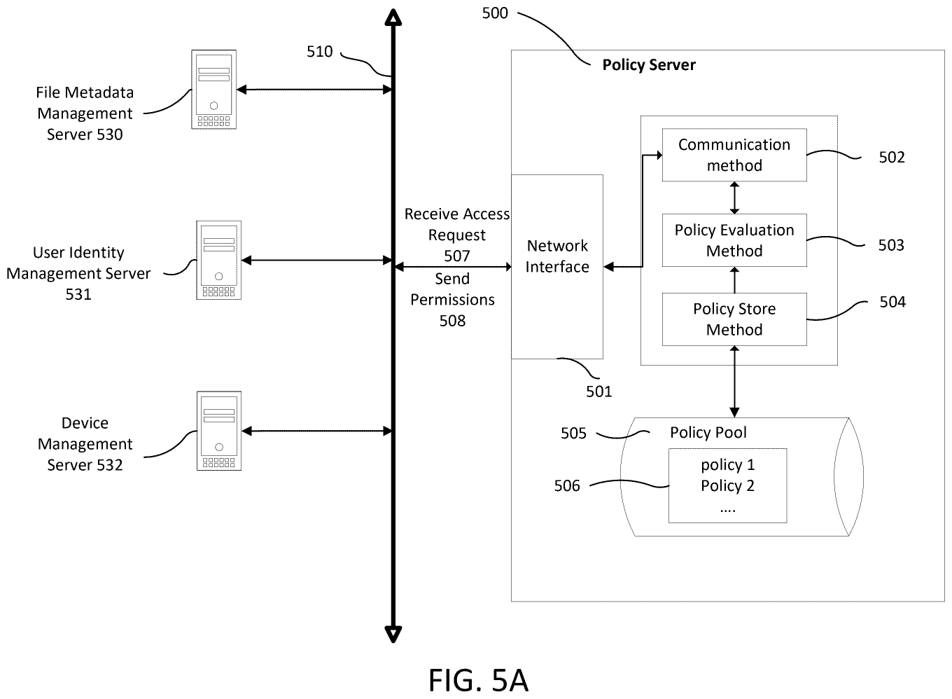

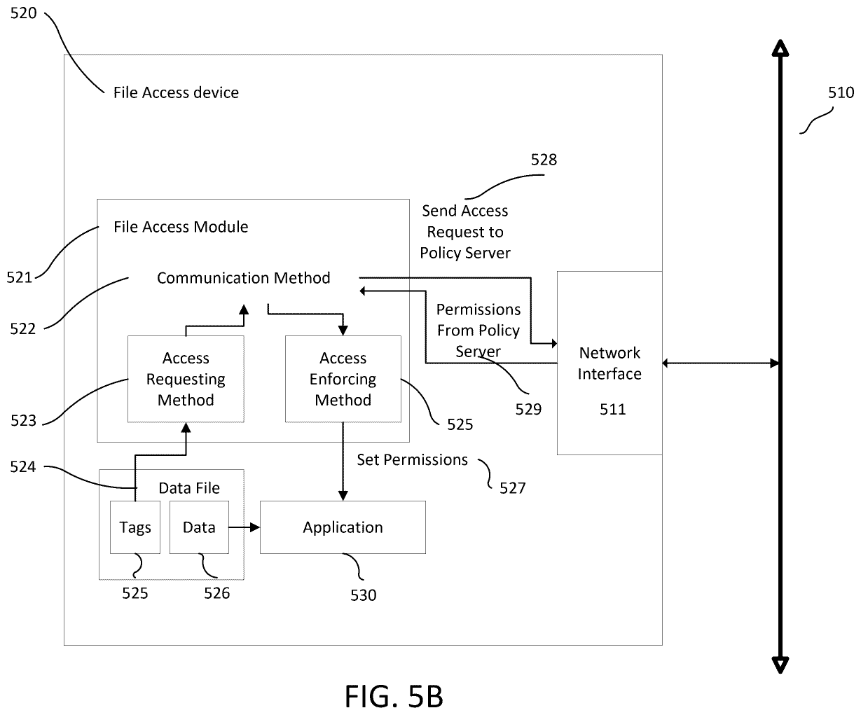

Arrive at 301, a request to access a file for a user on a device is received. In one embodiment, this request may originate from a remote device and be transmitted via the network, as described with reference to FIG. 5A and FIG. 5B. Subsequently, the resulting permission are sent back to the remote device through the same network. In another embodiment, the access policies are stored on the same device from which the request originates, and the request is received through inter-process interfaces such as Application Programming Interfaces (API) and local sockets. The resulting permissions are then relayed back to the requesting application locally via the same communication channel.

The access request may include a comprehensive set of metadata for the file being accessed, the attributes of the requesting user, and the properties of the device from which the request originates. This complete set of information can be used directly for policy evaluation.

In another embodiment, the request may only contain the necessary information to enable the policy evaluator to retrieve the required metadata, attributes, and properties from other systems or sources. For example, the request may include a file identifier, file path, or file name, allowing the policy evaluator to fetch the file's metadata from a separate file system or metadata repository via network communication or local inter-process communication.

Similarly, the request may include a user identifier, enabling the policy evaluator to retrieve the corresponding user attributes from an identity management system over the network. In scenarios where the request originates from a device different from the local system, the request may include a device identifier, allowing the policy evaluator to fetch the relevant device properties from a device management system or other appropriate sources.

As the file metadata, user attributes and device properties are collected and in the format that compliant with policies at 302. At 303, a target set with an empty set of permissions is created as a placeholder to accumulate the permissions granted based on the evaluation of applicable policies.

Next at step 304, a new policy is selected from the policy pool. If the policy is valid at 305, the process continues to policy evaluation.

At 306, the file metadata conditions are being evaluated. Each condition of the metadata conditions in the policy is being compared with the metadata associated with the file in the request. If any conditions are not satisfied, the selected policy is determined not to match the request and return to 304 to select the next unevaluated policy from the pool. If all the conditions are met, the evaluation moves to the next step 307.

Next at 307, the user attributes conditions are assessed. Each condition of the user attribute in the policy is compared with the data associated with the requesting user. If any conditions are not satisfied, the selected policy is determined not to match the request and return to 304 to select the next unevaluated policy from the pool. If all the conditions are met, the evaluation advances to the next step 308.

At 308, the device property conditions are evaluated. Each condition pertaining to device properties in the policy is compared with the properties of the device associated with the request. If any conditions are not satisfied, the policy is determined not to match the request and return to 304 to select the next unevaluated policy from the pool. Conversely, if all the conditions are met, the select policy is determined as to match the policy since all the conditions from metadata, user attributes and device properties are met. The process moves to merge the policy's permissions with the target set.

At 309, the permissions from the policy are merged with the target set using predefined rules, as described in reference to FIG. 2B. This merging process combines the permissions from the matching policy with the existing permissions in the target set, ensuring that all relevant permissions are accumulated.

The process returns to 304 to select the next unevaluated policy for this request for another iteration.

Upon reaching 305, if no policy is selected, it indicates that the policy pool has been exhausted for the current request, and the process moves to determine the final set of permissions.

At step 310, the process verifies if the target set is empty. An empty target set signifies that no policies matched the request throughout the evaluation process. In this scenario, a pre-defined default set of permissions is applied as the target set at 311. This default set is specifically designed to handle situations where no specific policies are applicable to a given request. The default set may grant a baseline level of permissions or deny access altogether, depending on the organization's security posture, data governance policies, and the desired behavior in the absence of matching policies.

However, if the target set is not empty at step 310, it indicates that at least one policy matched the request during the evaluation process. In this case, the target set, which now contains the merged permissions from all matching policies, becomes the final set of permissions.

At step 312, the target set of permissions, whether derived from the default set or the merged target set, is outputted as the result for the request. This result may then be sent to the requesting device or application for enforcement.

The sequence of evaluating each condition may or may not be significant depending on the implementation. For instance, one embodiment that prioritizes conditions likely to reject more requests at the top could enhance efficacy. This approach would lead to the rejection of more requests early in the process, reducing the need for unnecessary operations to compare the remaining conditions in the policy. Another embodiment uses “catch all” conditions may need to carefully consider the placement of the “catch all” conditions to ensure the function as expected.

Once the client application obtains the final set of permissions, it can enforce the granted access controls through various mechanisms, depending on the specific implementation and requirements. Some options for enforcing the permissions include:
File System Permissions: The client application may modify the file system permissions associated with the user and the file, aligning them with the granted read, write, and execute permissions. This approach directly updates the access control lists (ACLs) or other permission-related metadata at the file system level.
Access Control Lists (ACLs): If the underlying file system or storage system supports ACLs, the client application can directly modify the ACL entries associated with the file and the user, reflecting the granted permissions for that specific user-file combination.
File Metadata Modification: In some cases, the client application may modify the file's metadata to notify or instruct the applications or services designated to handle the file's content. This metadata could include flags or indicators related to the granted print and copy permissions, enabling those applications to enforce the appropriate restrictions or allowances.
Application-Level Access Control: Alternatively, the client application itself may implement application-level access control mechanisms based on the granted permissions. This approach may involve modifying the application's behavior, user interface, or functionality to restrict or allow certain operations, such as opening, modifying, printing, or copying the file's content, in accordance with the received permissions.

The choice of enforcement mechanism depends on factors such as the client application's architecture, the underlying file system or storage system capabilities, the integration with other applications or services, and the organization's security and data governance policies.

A client can aggregate multiple single file access requests into a single super request. In such embodiment, each requested file will undergo the same process (300) to obtain its individual access permissions. The access permissions for each requested file will be returned in a manner that allows the client to accurately retrieve the permissions for each file. A straightforward approach is to send the access permissions in the same order as the files in the corresponding request, enabling the client to correctly match each access permission with its respective requested file.

### Environments and Systems

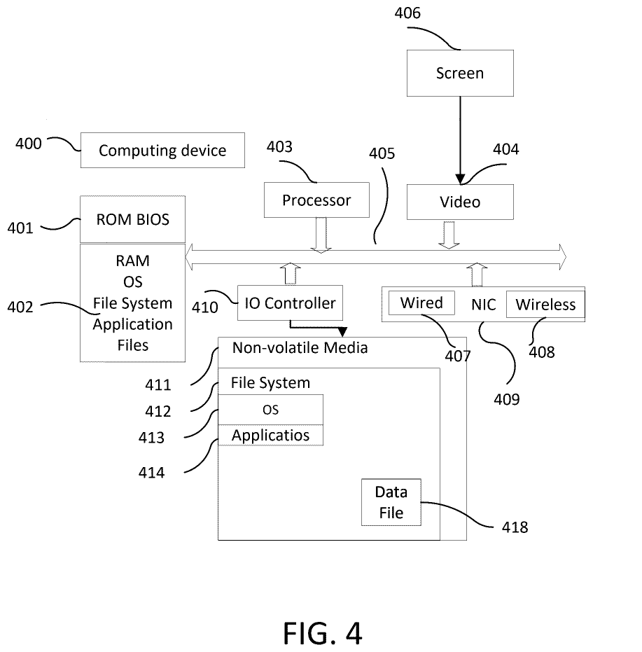

An access policy system in accordance with embodiments of the present invention may exist in various environments and are implemented on various devices. While FIG. 4 illustrates various components of a computer system, it is not intended to represent any particular architecture or manner of interconnecting the components as such details are not germane to the present invention. Other systems that have fewer or more components may also be used with the present invention.

As shown in FIG. 4, a computer system 400 is shown within which the present invention may be implemented. The computer system 400 may be a server, endpoint device, or a combination thereof and may be connected to other computer-based resources. The computer system 400 is suitable for storing and/or executing program code and includes at least one processor 403 coupled directly or indirectly to memory elements 401 and 403 through a bus system 405. The memory elements can include local memory employed during the actual execution of the program code, bulk storage, and cache memories which provide temporary storage of at least some program code in order to reduce the number of times the code must be retrieved from the bulk storage during execution.

The memory elements may include system memory in the form of read only memory (ROM) 401 and random-access memory (RAM) 402. A system pre-boot code including basic input-output system (BIOS) may be stored in ROM 401. Run time executable system software code may be stored in RAM 402 including an operating system 413 code. A file system 412 executable code associated with or included in the operating system 413 may also be stored in RAM 402 at runtime. Software applications 414 code may be stored in RAM 102 at runtime which interface with the operating system 413 and file system 412 through application programming interfaces (APIs).

The computer system 400 also includes non-volatile storage media 411 such as primary storage including a magnetic hard disk drive or solid-state disk driver and secondary storage including magnetic, solid state, optical disc drives and USB storage devices. The drives and their associated computer-readable media provide non-volatile storage of computer-executable instructions, data structures, program modules and data files for the system 400. Software applications and files are stored on the non-volatile storage media 411 and are loaded into system memory 402 during runtime.

The computer system 400 may operate in a networked environment using logical connections to one or more remote computers via a network adapter 409 which may be wired that uses wire as medium 407 and/or wireless that uses radio frequencies 408. A display device 106 is also connected to system bus 405 via an interface, such as video adapter 404.

The file system 412 connects through a device driver to communicate with a non-volatile storage device 111 and to manage the files thereon. A file system 412 generally includes methods for storing, referencing, sharing and securing files, accessing file data, and maintaining file integrity. There may not be a clear distinction between the file system 412 and the associated operating system 413. Any of the processes carried out by the file system 412 may be performed by the operating system 413.

FIG. 5A-5B illustrate an environment for creating access permissions to files in accordance with one embodiment of the invention. FIG. 5B shows a request for permission for a user to files on the system 520 may be sent from a client system 520 via a network 510 to server 500. The files in the request may be stored on the system 520 as shown in 524, or other systems or storages the user can fetch to the system 520 (not illustrated).

The file access system 520 may be a computing system 400, a mobile computing system, a mobile phone, a wireless handheld device, a server computing system, or a similar device. The file access system 520 may run a File Access Module as an application or as part of an integrated file system to manage access to data files 524. In one embodiment, the File Access Module locates the requested file 524 on the local file system and obtains the file's metadata 525, which is part of the file 524. It constructs the access request with the file metadata, the user's identification, and the device's identification, and sends the request through a communication method to the policy server 500, which it connects to via the network 510.

In another embodiment, the File Access Module may require the user running the application to authenticate with the policy server 500 (shown in FIG. 5A) before an access request can be sent. The authentication process may require the user's identification, along with the identification and properties of the device 520, to be sent to the policy server. In this case, the user's attributes or identification and the device's properties and identification are already known to the policy server. Therefore, the access request from the system 520 doesn't need to include that information in the request for the user from the device 520. The policy system will use the known user attributes and the device property information if they are missing from the requests.

Once the File Access Module receives the permissions from the policy server 529 via the network, it may enforce the permissions through an access enforcement method. This method may change the local file system permissions and modify the metadata of file 524 in accordance with the received permissions. This enables the file system and the application 530 to enforce the permissions based on the updated metadata and file system permissions.

The policy server, also known as policy evaluator, 500 in FIG. 5A may be a computing system 400 running a policy server application. The policy server application may have a program to create access policies by associating file metadata conditions, user attribute conditions, device property conditions, and a set of file access permissions together. Alternatively, it may have a program to receive access policies from client devices. The policy server application is also capable of storing policies 506 into a policy pool 505 through a policy store method 504.

The policy server 500 connects with file access devices via the network 510. It receives access requests 507 through a network interface using a communication method. The request is passed to a policy evaluation method, which fetches file metadata from the file metadata server 530 via the network 510 if a request does not contain the files' metadata but includes the necessary identifier for a file metadata management server 530.

It also fetches the user's attributes from a user identity management server 531 and the device's properties from a device management server 532 via the network 510 if the user's attributes or device's properties are missing from the request, or if dictated by the implemented embodiment.

The policy evaluation method then retrieves the relevant policies 506 from the policy pool 505 to be evaluated against each file in the access request. A policy server may store a pool of policies 505 in its local storage, or can access the policy pool that are stored in a remote database or storage system. Policies can be stored in various formats such as databases or text files, separate from the evaluator's code, making them configurable through user interfaces. These interfaces could include graphical user interfaces (GUIs), command line interfaces (CLIs), text editors, or Structured Query Language (SQL). Alternatively, policies can be embedded directly into the policy evaluator's code, resulting in unconfigurable rules. The policy evaluation process compares the file metadata, user attributes, and device properties from the request against the conditions specified in each policy. Policies that match the request's conditions are identified, and their associated permissions are combined according to predefined merge rules 201.

Finally, the policy server sends the final set of permissions of each file, resulting from the policy evaluation process, to the requesting device using the communication method in a manner that the requesting device can correctly retrieve the permissions for each file in the request. These permissions dictate the allowed actions and access levels for the requested file, user, and device combination.

It's worth noting that the policy server may implement caching mechanisms or other optimization techniques to improve the performance of policy evaluation, especially in scenarios where the same file metadata, user attributes, or device properties are frequently requested.

Network 510 may be any type of networks, both wired and wireless. Network 510 may use any available communications protocols, including various combinations of protocols at different open systems interconnection (OSI) model levels. For example, inter net protocol (IP), transmission control protocol (TCP), user datagram protocol (UDP), file transfer protocol (FTP), and hypertext transfer protocol (HTTP).

In addition, network 510 may include devices such as satellites, gateways and routers. As another example, network 510 may be a computing network which includes devices to transmit and receive signals from a console, through a wireless adapter to a router, to an ISP network of computers, through the Internet backbone and back through another set of devices to a data storage device

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, or semiconductor system (or apparatus or device) or a propagation medium. Examples of a computer-readable medium include a semiconductor or solid-state memory, magnetic tape, a removable computer diskette, a random-access memory (RAM), a read only memory (ROM), a rigid magnetic disk and an optical disk. Current examples of optical disks include compact disk read only memory (CD-ROM), compact disk read/write (CD-R/W), and DVD.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

### CONCLUSION

While the present invention has been described with reference to specific preferred embodiments, it is important to note that modifications and variations may readily occur to those skilled in the art. Therefore, all such variations and modifications are considered within the intended scope of the present invention as defined by the appended claims.

The detailed description includes numerous specific details to offer a comprehensive understanding of the present invention. However, these specific details are not necessarily required to practice the invention. Furthermore, well-known structures, materials, or processes may not be explicitly shown or described in detail to avoid unnecessarily obscuring the invention.

The provided description aims to enable a person of ordinary skill in the art to make and use the invention. Various modifications to the disclosed embodiments will be readily apparent to those skilled in the art, and the general principles defined herein may be applied to other embodiments and applications without departing from the scope of the present invention.

It is intended that the present invention encompass such modifications and variations as long as they come within the scope of the appended claims and their equivalents. Therefore, the present invention should not be limited to the specific embodiments described herein, but rather should extend to all possible variations and modifications that fall within the scope of the appended claims and their equivalents.

The term “file” as used herein may refer to any file created on a computing system. It encompasses a collection of bytes or bits stored as an individual entity. Examples of files include, but are not limited to: binary files, text files, Word processor documents, spreadsheets, workbooks, image files, drawings, audio files, video files, audio/visual files, archive files, source code files, object files, executable programs. Additionally, the term “file” may also refer to a file system object that is accessed as though it were a file. A file or document may reside on a single system or may be accessed by one or more systems via a network, such as an intranet or the internet.

It is important to note that the term “file” as used herein is not limited to the specific examples provided, but rather encompasses any collection of data stored as an individual entity on a computing system, regardless of its format, structure, or intended use.

Reference to a “server” as used herein may include a software application that carries out tasks on behalf of users, such as file serving, application serving, web serving, email serving, and the like. The term “server” as used herein may also encompass any physical device on which such software is executed, including but not limited to mainframes, minicomputers, personal computers, dedicated server machines, and similar devices.

Reference to a “client” and “endpoint device” as used herein may include any system that accesses a service on another system by means of some kind of network. These clients include, but are not limited to, systems referred to as terminals, personal computers, thin clients, mobile phones, wireless handheld devices, game consoles and other devices capable of accessing remote services over a network.

Unless specifically stated otherwise, it should be appreciated that throughout the discussions, terms such as “processing,” “storing,” “calculating,” “determining,” “evaluating,” or similar terms refer to the actions and processes performed by a computer system or similar electronic computing device. These actions and processes involve manipulating and transforming data represented as physical (e.g., electronic) quantities within the computer system's registers and memories into other data similarly represented as physical quantities within the computer system.

It is important to note that the terms “server” and “client” are not limited to the specific examples provided, but rather encompass any software or hardware components that fulfill the respective roles of providing services and accessing services over a network, respectively.

The present invention can be realized through an apparatus designed to perform the described operations. This apparatus may be custom-built for specific purposes or may comprise a machine such as a general-purpose computer that is selectively activated or reconfigured by a computer program.

It's worth noting that the invention can be applied to a wide range of systems, including stand-alone computers, handheld devices, multi-processor systems, microprocessor-based or programmable consumer electronics, network personal computers, mainframe computers, and others.

The method of the invention can be implemented using computer software. When written in a programming language conforming to recognized standard sequences of instructions, these methods can be compiled for execution on various hardware platforms or machines and interfaced with different operating systems. Additionally, the present invention is not tied to any specific programming language, and various languages may be used to implement the described teachings.

What is claimed is:

1. A computer-implemented method comprising:
Associating, by a computer system, a set of conditions to match metadata of a plurality of files, a set of conditions to match attributes of a plurality of users, and a set of conditions to match properties of a plurality of devices, with a set of access permissions that may be used to control users' access to files, thereby creating an access policy; and
storing a plurality of access policies; and
upon receiving a request for a user to access a file on a device, determining access permissions for the request by matching conditions of each of the stored policies to the user's attributes, the file's metadata and the device's properties associated with the request, and merging the permissions from the policies of which all conditions are met into final permissions, and output the final permissions to be sent to the requesting device or application.

2. The method in claim 1, wherein the metadata of a file is a set of data linked with the file, and the attributes of a user is a set of data linked with the user, and the properties of a device is a set of data linked with the device.

3. The method of claim 1, wherein the metadata of the file, the attributes of the user and the properties of the device are either included in the request, or are retrievable using the information associated with the request.

4. The method of claim 1, wherein the access permissions from policies include denying access to the content of a file, allowing read only access to the content of a file, allowing read and write access of the content of a file and allowing read and execution access to the content of a file.

5. A system comprising: a processor and a memory comprising instructions executable by the processor to:
store a plurality of policies, each policy comprising conditions to match metadata of a plurality of files, conditions to match attributes of a plurality of users, conditions to match properties of a plurality of devices, and a set of access permissions;
receive a request for a user to access a file on a device, and
retrieve the file's metadata, the user's attributes, and the device's property either from the request or from other sources using the information associated with the request, and determine the user's access permissions to the file on the device by comparing each of the stored policies with the file's meta data, the user's attributes and the device's properties, and merge the permissions from the policies that satisfy all conditions into a final set of permissions, and output the final permissions to be sent to the requesting device or application.

6. The system of claim 5, wherein the memory further comprises instructions executable by the processor, upon receiving a request from a user to access a file on a device, to return a set of access permissions by merging the permissions from the stored policies where the conditions from each policy match the metadata of the file, the attributes of the user and the properties of the device associated with the request.
